(19) United States
(12) Patent Application Publication
(10) Pub. No.: US 2026/0032211 A1
(43) Pub. Date: Jan. 29, 2026

(54) COLOR-GRADING CONTENT BASED ON SIMILARITY TO EXEMPLARS

(71) Applicant: DOLBY LABORATORIES LICENSING CORPORATION, San Francisco, CA (US)

(72) Inventor: Gregory John Ward, Berkeley, CA (US)

(73) Assignee: DOLBY LABORATORIES LICENSING CORPORATION, San Francisco, CA (US)

(21) Appl. No.: 18/996,866

(22) PCT Filed: Jul. 20, 2023
(86) PCT No.: PCT/US2023/070581

§ 371 Date: Jan. 17, 2025

Related U.S. Application Data
(60) Provisional application No. 63/391,528, filed on Jul. 22, 2022.

(30) Foreign Application Priority Data
Sep. 23, 2022 (EP) 22197590.7

(51) Int. Cl. H04N 1/60; G06T 3/40; G06V 10/60; G06V 10/74

(52) U.S. Cl. CPC H04N 1/6075; G06T 3/40; G06V 10/60; G06V 10/761; H04N 1/6005

(57) ABSTRACT

Systems and methods for color grading of images and video based on similarity to exemplars. In preparation for color-grading new content, exemplar frames related to the expected new content may be obtained and color grading parameters for the exemplar frames may be obtained. To color grade the new content as it is created or received, similarities between frames of the new content and the exemplar frames may be determined. The similarities between frames of the new content and the exemplar frames may be determined may be combined with the obtained color-grading parameters from the exemplar frames to determine suitable color-grading parameters to apply to the new content. The new content may then be color-graded using the determined color-grading parameters.

### CROSS-REFERENCE TO RELATED APPLICATIONS

This application claims priority to U.S. Provisional Patent Application No. 63/391,528, filed Jul. 22, 2022, and European Patent Application 22197590.7, filed 23 Sep. 2022, which are hereby incorporated by reference in their entirety.

### FIELD OF THE DISCLOSURE

This application relates generally to systems and methods of image processing, image display, and image reproduction. Embodiments of the invention provide methods and apparatus which process image data to transform colors and/or tones for display or reproduction locally or at a downstream device. Some example embodiments are displays configured to receive and process image data and to display processed image data for viewing.

### SUMMARY

The invention is defined by the independent claims. Dependent claims concern optional features of some embodiments of the invention. Embodiments described herein relate to systems and methods for color grading of images and video based on similarity to exemplars. In preparation for color-grading new content, exemplar frames related to the expected new content may be obtained and color grading parameters for the exemplar frames may be obtained. To color grade the new content as it is created or received, similarities between frames of the new content and the exemplar frames may be determined. The similarities between frames of the new content and the exemplar frames may be combined with the obtained color-grading parameters from the exemplar frames to determine suitable color-grading parameters to apply to the new content. The new content may then be color-graded using the determined color-grading parameters

In one exemplary aspect of the present disclosure, there is provided a method for color-grading a source image using a plurality of color-grading operations. The method includes obtaining a source image for color-grading; obtaining, in association with each example frame from a plurality of example frames, a plurality of color-grading parameter settings, where each color-grading parameter setting serves as an input parameter for an associated color-grading operation out of the plurality of color-grading operations; obtaining a plurality of similarity measurements, each similarity measurement indicating a level of similarity between the source image and a different respective example frame from the plurality of example frames; obtaining a plurality of weighted averages based on the similarity measurements and the plurality of color-grading parameters, where each weighted average is associated with a different respective color-grading operation out of the plurality of color-grading operations; applying, to produce a color-graded image, the plurality of color-grading operations to the source image using each of the weighted averages as an input parameter to its associated color-grading operation; and providing the color-graded image.

In another exemplary aspect of the present disclosure, there is provided a color-grading system that includes at least one controller configured to obtain a source image for color-grading; obtain a plurality of color-grading parameter settings, where each color-grading parameter setting serves as an input to a color-grading operation and where each color-grading parameter setting is associated with a different respective example frame from a plurality of example frames; calculate a plurality of similarity measurements, each similarity measurement indicating a level of similarity between the source image and a different respective example frame from the plurality of example frames; calculate a weighted average based on the plurality of similarity measurements and the plurality of color-grading parameter settings; apply, to produce a color-graded image, the color-grading operation to the source image using the weighted average as an input parameter to the color-grading operation; and provide the color-graded image.

In another exemplary aspect of the present disclosure, there is provided a method that includes obtaining a sequence of image frames; obtaining a plurality of similarity measurements, each similarity measurement indicating a level of similarity between a different respective pair of image frames from the sequence of image frames; and selecting, from the sequence of image frames, a set of exemplar frames, by (i) adding, to the set of exemplar frames, a first image frame from the sequence of image frames; (ii) identifying, from among the image frames not yet added to the set of exemplar frames, which image frame is the least similar, according to the similarity measurements, to the image frame(s) in the set of exemplar frames; (iii) adding, to the set of exemplar frames, the image frame identified in (ii); and (iv) repeating (ii) and (iii) until a completion condition is satisfied.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

At least some aspects of the present disclosure may be implemented via an apparatus. For example, one or more devices may be capable of performing, at least in part, the methods disclosed herein. In some implementations, an apparatus is, or includes, an audio processing system having an interface system and a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### DESCRIPTION OF THE DRAWINGS

These and other more detailed and specific features of various embodiments are more fully disclosed in the following description, reference being had to the accompanying drawings, in which:

FIG. 1 depicts an example process for image encoding and decoding pipelines.

FIG. 2 depicts an example process for an imaging encoding pipeline.

FIG. 3 depicts an example process for identifying exemplar frames.

### DETAILED DESCRIPTION

This disclosure and aspects thereof can be embodied in various forms, including hardware, devices or circuits controlled by computer-implemented methods, computer program products, computer systems and networks, user interfaces, and application programming interfaces; as well as hardware-implemented methods, signal processing circuits, memory arrays, application specific integrated circuits (ASICs), field programmable gate arrays (FPGAs), and the like. The foregoing is intended solely to give a general idea of various aspects of the present disclosure, and does not limit the scope of the disclosure in any way.

In the following description, numerous details are set forth, such as optical device configurations, timings, operations, and the like, in order to provide an understanding of one or more aspects of the present disclosure. It will be readily apparent to one skilled in the art that these specific details are merely exemplary and not intended to limit the scope of this application.

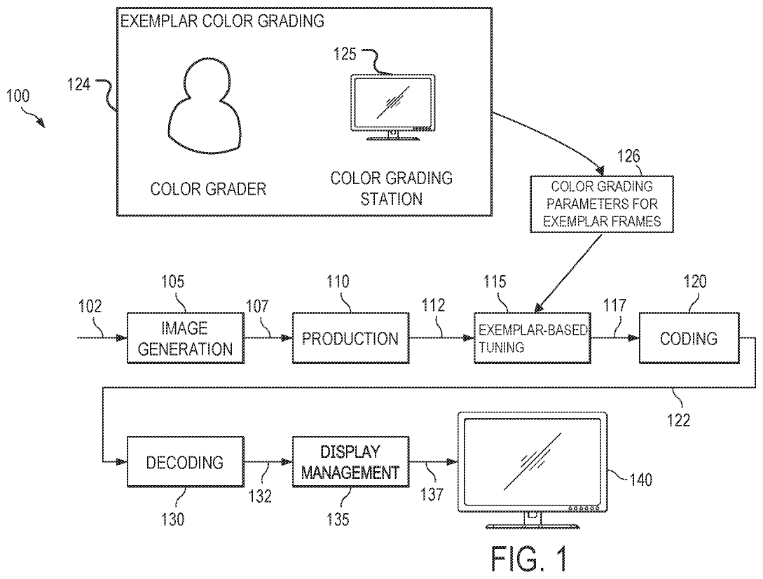

FIG. 1 depicts an example process of an image delivery pipeline (100) showing various stages from image capture to image content display. An image (102), which may include a sequence of video frames (102), is captured or generated using image generation block (105). Image (102) may be digitally captured (e.g., by a digital camera) or generated by a computer (e.g., using computer animation) to provide image data (107). Alternatively, image (102) may be captured on film by a film camera. The film is converted to a digital format to provide image data (107). In a production phase (110), image data (107) is edited to provide an image production stream (112).

The image data of production stream (112) is then provided to a processor (or one or more processors such as a central processing unit (CPU)) at block (115) for exemplar-based color grading (e.g., real-time production editing). Block (115) exemplar-based color grading may include adjusting or modifying colors or brightness in an image to enhance the image quality or achieve a particular appearance for the image in accordance with the image creator's creative intent. This is sometimes called “color timing” or “color grading.” Methods described herein may be performed by the processor at block (115). The image data from exemplar-based color grading (115) yields a final version (117) of the production for distribution.

Exemplar-based color grading (115) and pipeline (100) of FIG. 1 may be configured for delivering live content where dynamic conditions produce unpredictable imagery, such as in live broadcasts, gaming content, virtual reality content, and the like. When delivering such live content, it is generally not possible for a creative artist or other user to manually color grade each image frame (to enhance the image quality or achieve a particular appearance for the image in accordance with the image creator's creative intent). For example, while the creative artist could provide a single set of color-grading parameters or adjustments to apply to all image frames, fixed color-grading adjustments would be ill-suited to the changing conditions of live content.

Exemplar-based color grading (115) leverages predetermined color grading parameters for exemplar frames (126) to a range of unknown future views and conditions, enabling the color-grading of live content. As an example, an image creator can, as part of exemplar color grading (124), obtain past live content (e.g., a prior live broadcast, a clip of gaming content, a clip of virtual reality content, etc.), identify exemplar frames from the past live content, and provide their artistic input using color grading station (125) to manually color-grade the exemplar frames. Then, when new live content is being processed through exemplar-based color grading (115) and pipeline (100), frames of the live content can be compared for similarities to the manually color-graded exemplar frames. The new frames can then be automatically color-graded, by transferring the image creator's color-grading of the exemplar frames to the new frames, based on similarities between the new frames and the color-graded exemplar frames. In this manner, exemplar-based color grading (115) and pipeline (100) of FIG. 1 can color-grade live content in real-time or near real-time, despite the somewhat unpredictable nature of live content.

In some embodiments, the color grading operations applied in exemplar-based color grading (115) and exemplar-based color grading (124) may include operations whose effect on the image output is roughly monotonic. A color grading operation may be roughly monotonic when changes in a particular direction of the setting for that operation also move the output in a particular direction, without doubling back. As a particular example, a brightness control with a range of settings from 0 to 1 should not make the image brightest at a setting of 0.5, but should instead always increase brightness as the setting is increased from 0 to 1. Examples of color grading operations that may be applied in exemplar-based color grading (115) and exemplar-based color grading (124) include, but are not limited to, adjustments to ambient color temperature, contrast, luminance, hue, color-saturation, highlights, shadows, white clipping, black clipping, slope (multiplying brightness and/or one or more chromaticity channels by a factor), offset (adding an offset to brightness and/or one or more chromaticity channels), etc.

Following exemplar-based color grading (115), image data of final production (117) may be delivered to encoding block (120) for delivering downstream to decoding and playback devices such as computer monitors, television sets, set-top boxes, movie theaters, and the like. In some embodiments, coding block (120) may include audio and video encoders, such as those defined by ATSC, DVB, DVD, Blu-Ray, and other delivery formats, to generate coded bit stream (122). In a receiver, the coded bit stream (122) is decoded by decoding unit (130) to generate a decoded signal (132) representing an identical or close approximation of signal (117). The receiver may be attached to a target display (140) which may have unique characteristics. In that case, a display management block (135) may be used to map the dynamic range of decoded signal (132) to the characteristics of the target display (140) by generating display-mapped signal (137). Additional methods described herein may be performed by the decoding unit (130) or the display management block (135). Both the decoding unit (130) and the display management block (135) may include their own processor or may be integrated into a single processing unit. While the present disclosure refers to a target display (140), it will be understood that this is merely an example. It will further be understood that the target display (140) can include any device configured to display or project light; for example, computer displays, televisions, OLED displays, LCD displays, quantum dot displays, cinema, consumer, and other commercial projection systems, heads-up displays, virtual reality displays, and the like.

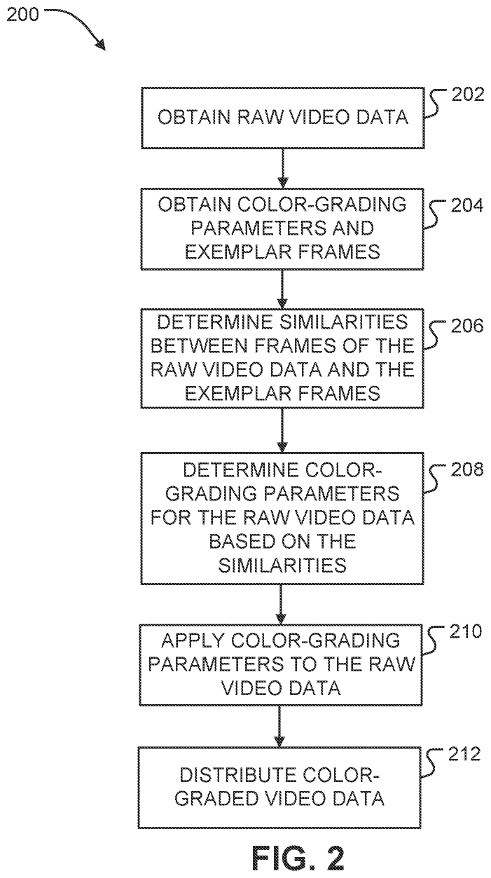

FIG. 2 provides a method (200) to allow for color grading based on similarity to exemplar frames. The method (200) may be performed by, for example, the processor as part of block (115) and/or block (120) for encoding.

At step (202), raw video (or image) data is obtained. The raw video (or image) data may, as examples, be live content such as live broadcasts, gaming content, virtual reality content, and the like.

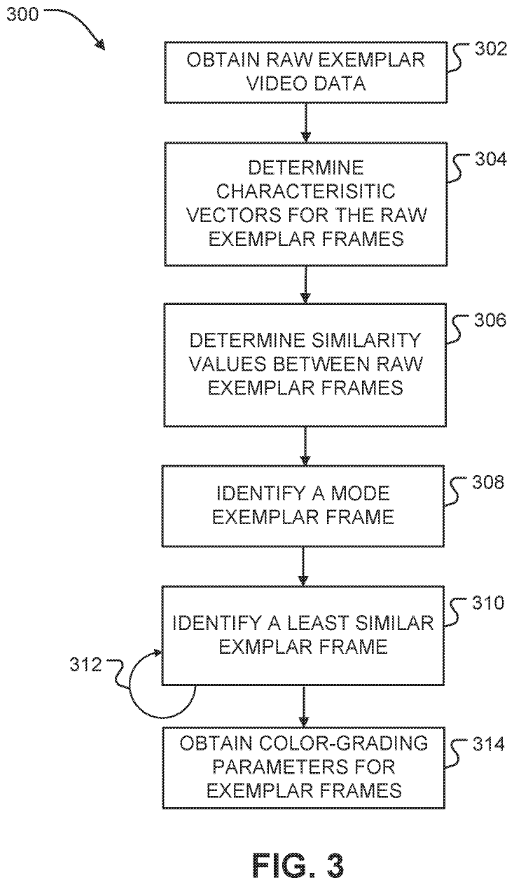

At step (204), exemplar frames and pre-determined color-grading parameters are obtained. The exemplar frames may be frames from historical live content. In some embodiments, the exemplar frames are selected according to the method (300) of FIG. 3. In some embodiments, the pre-determined color-grading parameters are obtained through a color grading station, such as station (125) of FIG. 1, and as part of the method (300) of FIG. 3. Step (204) may involve obtaining a plurality of exemplar frames and, for each exemplar frame, one or more color grading parameters (which may also be referred to as color grading parameter settings or color grading settings). The color grading parameters obtained in step (204) may include any color grading parameters that are adjustable via color grading station (125) or another color grading device.

At step (206), the method may involve determining similarities between frames of the raw video (or image) obtained in step (202) and the exemplar frames obtained in step (204). In some embodiments, a characteristic vector may be computed for each image frame obtained in step (202) and for each exemplar frame obtained in step (204). The characteristic vectors for raw video data may be computed in real-time or, when dealing with recorded rather than live content, may be computed any time before step (206). The characteristic vectors for the exemplar frames may be computed during step (204) or as part of the operations of method (300) of FIG. 3, as examples. The characteristic vectors may be used in determining the similarities between frames of raw video (or an image) and the exemplar frames obtained in step (204). The characteristic vector for each frame may include, as examples, non-zero bin counts in a 3-D histogram binning value populations in a preferred color space, plus averages and standard deviations for brightness in a predetermined number of horizontal zones partitioned from top to bottom in the frame.

Step (206) may include computing a 3-D histogram for some, or each, of the image frames obtained from steps (204 and 206). Each 3-D histogram may include bins that divide an initial luminance range into down-sampled ranges and that divides chromaticity parameters (such as the u′ and v′ parameters of the CIE, International Commission on Illumination) into down-sampled ranges. As an example, image frames encoded with a perceptual quantizer based on Society of Motion Picture and Television Engineers ST.2084 (SMPTE 2084) may initially have a luminance range of 0-10,000 cd/m² encoded with 10 to 16 bits and may have a pair of chromaticity parameters, each encoded with 10 to 16 bits. As part of calculating the characteristic vectors the initial luminance range may be divided into a limited number of ranges, such as 16 luminance bins (e.g., a 4 bit depth) and each chromaticity parameter may similarly be divided into a limited number of ranges, such as 8 chromaticity parameter ranges (e.g., a 3 bit depth). The divided luminance ranges may each be sized so that each spans a relatively similar perceptual difference. In other words, if the brightest value in a given divided luminance range had a perceptual brightness approximately double the dimmest value in that same luminance range, it may desirable for the remaining luminance ranges to also have brightest values with a perceptual brightness approximately double their dimmest value. As an example, step (206) may include populating a 3-D histogram for some, or all, of the image frames obtained from steps (204 and 206), where a first dimension of the histogram relates to luminance, a second dimension relates to a first chromaticity parameter (e.g., u′), and a third dimension relates to a second chromaticity parameter (e.g., v′). Each dimension may include any desired number of bins. As an example, there may be 16 bins (e.g., 16 distinct luminance ranges) in the luminance dimension, 8 bins (e.g., 8 distinct ranges of u′) in in the first chromacity dimension, and 8 bins (e.g., 8 distinct ranges of v′) in the second chromaticity dimension.

Computing a 3-D histogram for a given image frame, such as one of the image frames obtained from steps (204 and 206), may include counting the number pixels in the given image associated with each bin of the 3-D histogram. In other words, if a given bin in the 3-D histogram covers a luminance range, a chromaticity range in the first chromaticity dimension, and a given chromaticity range in the second chromaticity dimension and the image frame at issue includes X pixels that fall within all three independent ranges of that given bin, then the given bin may be assigned a value of X.

In some embodiments, the resolution of image frames may be downsampled as part of calculating their characteristic vectors, which may reduce the processing load of calculating characteristic vectors. As an example, image frames may be downsampled to a resolution of 100 by 100 pixels, 150 by 150 pixels, 180 by 180 pixels, 200 by 200 pixels, 250 by 250 pixels, or another desired resolution. Down-sampling of the image frames may be done with, or without, maintaining an initial aspect ratio of the image frames. In such embodiments, the pixel counts in the 3-D histogram may be based on a down-sampled versions of the image frames.

Step (206) may also include computing averages and standard deviations for brightness in a predetermined number of horizontal zones partitioned from top to bottom in the subject frame. As an example, computing the characteristic vector for a given image frame may involve dividing that given image frame into a predetermined number of horizontal zones, then computing the average brightness of each horizontal zone and the standard deviation of brightness of each horizontal zone. For example, each of the horizontal zones may span the entire width of the subject frame while spanning a respective fraction of the vertical dimension. The horizontal zones may, if desired, have similar or identical sizes (e.g., each horizontal zone may span a similar or identical fraction of the vertical dimension) or may have different sizes. As example, a central horizontal zone may have a larger, or smaller, vertical span than another horizontal zone below or above that central horizonal zone. The horizontal zones may partially overlap, may about each other with no overlap or vertical gap, or may be separated by a vertical gap. As examples, the predetermined number of horizonal zones may be three horizontal zones, four horizontal zones, five horizontal zones, six horizontal zones, seven horizontal zones, eight horizontal zones, nine horizontal zones, ten horizonal zones, or more than ten horizontal zones. If desired, the calculations for averages and standard deviations for brightness in a predetermined number of horizontal zones may be performed after downsampling the original image (as discussed above).

Step (206) may also include comparing the characteristic vectors of the raw video frames with the characteristic vectors of the exemplar frames. As an example, the characteristic vector of some or each raw video frame may be compared to the characteristic vectors of the exemplar frames. Determining the similarity of the characteristic vector for a raw video frame with the characteristic vector for an exemplar frame may include comparing the 3-D histogram bin populations of the two image frames and comparing the average and standard deviation of brightness across the aforementioned horizontal zones, then combining those two comparisons.

Comparing the 3-D histogram bin populations of two image frames may involve, as an example, calculating a sum of overlap in the 3-D histogram bin populations of the two image frames. As a specific example, if a given 3-D histogram bin has a non-zero value of X for a given raw video frame and a non-zero value of Y for a given exemplar frame, then the lesser value of X and Y may be added to a sum indicative of similarity between the frames. Such a calculation may be repeated for some or all of the 3-D histogram bins, until a final sum of overlap in the 3-D histograms is obtained. If the two 3-D histograms are identical, the total will equal 100% (1.0). If there is no overlap in the two 3-D histograms, the total will be 0% (0.0). Most frames will have some pixels in common, so will be between these two extremes and so will have a final normalized similarity in 3-D histogram bin populations in the range of 0.0 to 1.0.

Comparing the average and standard deviation of brightness across the aforementioned horizontal zones may involve, as an example, computing the normal distribution overlap between the mean and standard deviations of each of the horizontal zones of the two image frames being compared. The normal distribution overlap between the matching horizontal zones of the two images frames may be a real value in the range of 0.0 to 1.0. In some embodiments, the normal distribution overlaps of different horizontal zones may be averaged together to yield an overall matching value also in the range of 0.0 to 1.0. If desired, the lowest horizontal zones may have a first weighting (W1), the second lowest horizontal zones may have a second weighting (W2), the central horizontal zones may have a second weighting (W3), the second uppermost horizontal zones may have a fourth weighting (W4), and the uppermost horizontal zones may have a fifth weighting (W5), where some or all the weightings may be unique. In some embodiments, the weighting (W3) of the central horizontal zones may be greater than the weighting of other horizontal zones. Computing the normal distribution overlap of the horizontal zones of two image frames may, as an example, involve calculating a weighted average of the normal distribution overlaps of each of the horizontal zones.

The outputs of the 3-D histogram bin comparison and the normal distribution overlap of the horizontal zones may be combined together using any desired weighting factors. As an example, the two measures may be combined with an equal ½ weighting. In some embodiments, the two measures may be combined with unequal weightings (e.g., the 3-D histogram bin comparison may be given a higher or lower weighting than the normal distribution overlap). In some embodiments, the output of the 3-D histogram bin comparison includes a similarity value in the range of 0.0 to 1.0 and the normal distribution overlap of the horizontal zones also includes a similarity value in the range of 0.0 to 1.0. When these two comparison metrics are aggregated with an equal ½ weighting, the final similarity value between a given raw frame and a given exemplar frame may also have a range of 0.0 to 1.0.

At step (208), the similarity values between the one or more raw frames and the exemplar frames and the pre-determined color-grading parameters obtained in step (204) which are associated with the exemplar frames may be combined to determine color-grading parameters for the raw frames. In some embodiments, the similarity values obtained in step (206) may be used to assign weights for the pre-determined color grading parameters associated with the exemplar frames. If a raw frame is exactly the same as an exemplar frame (e.g., has a similarity value of 1.0), then the set of pre-determined color grading parameters of that exemplar frame may have a maximum weighting. In contrast, if a raw frame and an exemplar frame have a similarity value of 0.0, then the set of pre-determined color grading parameters of that exemplar frame may have a zero weighting. In some embodiments, the weights of pre-determined color grading parameters from an exemplar frame j for application to a raw frame i may be calculated using equation (1).

$$w ( i , j ) = s ( i , j ) / [ Ks - s ( i , j ) ] \qquad ( 1 )$$

In equation (1), w(i,j) may represent the weight for raw frame i relative to exemplar frame j, s(i,j) may represent the similarity between raw frame i and exemplar frame j, and K_{S} may be a pre-determined constant value, which may be greater than 1.0. In sone embodiment, K_{S} may have a value of 1.05, which yields a maximum weighting of 20. Other formulas to convert the similarity values to weights may be used in place of formula (1).

As discussed above, there may be M characteristic vectors (one for each of M exemplar image frames) and each characteristic vector may have an associated set of between 1 and N tone-mapping parameter settings. Some characteristic vectors (e.g., some exemplar images) may be associated with tone-mapping parameter settings for all N possible tone-mapping operations, while other characteristic vectors (e.g., other exemplar images) may be associated with tone-mapping parameters settings for less than the N possible tone-mapping operations and may be associated with as few as a single tone-mapping parameter setting for a single tone-mapping operation out of the N possible tone-mapping operations. As a new raw image frame arrives (e.g., in step (302)), the new raw image frame may be optionally downsampled and its characteristic vector computed. The characteristic vector of the new raw image frame is then compared to each of the M characteristic vectors of the exemplar frames, to arrive at M similarity values. The M similarity values may, if desired, be converted into M weights (e.g., using formula (1) above). Then, as part of step (208), N color-grading parameters for N tone-mapping operations for the new raw image frame may be determined using the M weights (or the M similarity values). In some embodiments, each of the N tone-mapping parameters for the new raw image frame may be calculated using a weighted average. As one example, the N tone-mapping parameters for the new raw image frame may be calculated using the weighted average of equation (2).

$$p ( k , i ) = [ {Σ}_{j} p ( k , j ) w ( i , j ) ] / {Σ}_{j} w ( i , j ) \qquad ( 2 )$$

In equation (2), p(k,i) represents the parameter setting for tone-mapping operation k to apply to new frame i, p(k,i) represents the parameter setting for tone-mapping operation k that was applied to the exemplar frame j, and w(i,j) represents the weight for raw frame i relative to exemplar frame j (as discussed in connection with equation (1)). In some embodiments, only exemplars that have provided or associated settings for the kin tone-mapping operation are used in the weighted average of equation (2). In situations where there are no non-zero weights for a specified tone-mapping operation (e.g., there are no exemplars having both a provided setting for the k^{th} tone-mapping operation and a non-zero weighting relative to the new frame), the method may instead assign a global default value for the kin tone-mapping operation. Content creators may provide global default values for any desired number of the N possible tone-mapping operations.

At step (210), each of the tone-mapping operations N may be applied to the raw video frame, where each tone-mapping operation is applied using its associated parameter setting determined in step (208). In this manner, tone-mapping operations can be applied to raw video frames in real-time without requiring manual review or inputs from a color grader. At step (212), the color-graded video frames may be distributed for use and/or storage.

FIG. 3 provides a method (300) for identifying exemplar frames and obtaining color-grading parameters for those exemplar frames, for use in method (200) of FIG. 2. The method (300) may be performed by, for example, the processor as part of block (124) and/or block (126). A content creator may have access to a past live broadcast or sample gameplay footage (e.g., a set of possible exemplar frames), but it may be undesirable for the content creator to individually color grade every single possible exemplar frame. The method (300) may be one example of a method for narrowing down the set of possible exemplar frames into a more limited and still appropriate set of exemplar frames for individual color grading. As an example, it may be desirable for the individually color graded exemplar frames to be a manageable number, while also being as distinct as possible to cover the widest range of possible future raw video inputs.

At step (302), raw exemplar video data may be obtained, where the raw exemplar video contains X possible exemplar frames. The raw exemplar video data may be associated with the future raw video that is to be color graded. As an example, if the raw video to be color graded is a future broadcast of a sports event, then step (302) may involve obtaining past broadcasts of similar sports events (e.g., prior matches at the same location, at similar times of day, etc.). As another example, if the raw video to be color graded is gaming content from a particular game, then step (302) may involve obtaining sample content from that particular game.

At step (304), characteristic vectors for some or all of the raw exemplar video frames may be calculated, where the characteristic vectors may be calculated as described in step (206) of method (300).

At step (306), similarity values between the characteristic vectors and their associated raw exemplar video frames may be calculated (e.g., as described in step (206). If desired, step (306) may involve populating a symmetric matrix with a 1.0 diagonal (e.g., the similarity of each frame to itself) otherwise indicating the similarity values between the characteristic vectors and their associated raw exemplar video frames.

At step (308), a mode exemplar frame may be identified and selected as the first exemplar frame in a set of M final exemplar frames. As an example, step (308) may involve finding which row of the symmetric matrix has the largest sum, which indicates the most average frame (e.g., mode) of the raw exemplar video frames.

At step (310), a frame having the smallest maximum similarity to the exemplar frame(s) in the set of final exemplar frames may be identified, and then added to the set of final exemplar frames. As an example, step (310) may involve identifying which row in the symmetric matrix has the smallest maximum value (excluding the 1.0 diagonal) and the exemplar frame associated with that row may be added to the set of final exemplar frames.

As indicated by loop (312), step (310) may be repeated until an end condition is reached. Examples of potential end conditions include, but are not limited to, reaching a predetermined number (M) of final exemplar frames and the candidate identified in step (310) having a similarity to a prior entry in the set of final exemplar frames greater than a predetermined threshold. As an example, if the frame identified in step (310) as having the smallest maximum similarity to the exemplar frame(s) in the set of final exemplar frames has a maximum similarity of at least 0.7 to a frame already in the set of final exemplar frames, method (300) may cease loop (312) and the finally-identified frame may or may not be added to the set of final exemplar frames.

At step (314), color-grading parameters for the exemplar frames identified in step (310) may be obtained. The color-grading parameters may be obtained, as an example, by a color grader using color grading station (125). In particular, a color grader may provide inputs via a control interface of a color grading station. If desired, step (310) and/or step (314) may also involve receiving user input to remove one or more exemplar frames from the set of final exemplar frames identified in step (310). In particular, method (300) may identify some exemplar frames that are not particularly useful for color grading, such as frames during a fading transition, completely black frames, etc. It should generally be easier to exclude such frames from the smaller set of exemplar frames identified in step (310) than from the original raw exemplar frames obtained in step (302).

The above systems and methods may provide for color grading of images and video based on similarity to exemplars. Systems, methods, and devices in accordance with the present disclosure may take any one or more of the following configurations.

(1) A method for color-grading a source image using a plurality of color-grading operations, the method comprising: obtaining a source image for color-grading; obtaining, in association with each example frame from a plurality of example frames, a plurality of color-grading parameter settings, wherein each color-grading parameter setting serves as an input parameter for an associated color-grading operation out of the plurality of color-grading operations; obtaining a plurality of similarity measurements, each similarity measurement indicating a level of similarity between the source image and a different respective example frame from the plurality of example frames; obtaining a plurality of weighted averages based on the similarity measurements and the plurality of color-grading parameters, wherein each weighted average is associated with a different respective color-grading operation out of the plurality of color-grading operations; applying, to produce a color-graded image, the plurality of color-grading operations to the source image using each of the weighted averages as an input parameter to its associated color-grading operation; and providing the color-graded image.

(2) The method according to (1), wherein the plurality of color-grading operations comprises a luminance adjustment operation, a hue adjustment operation, and a saturation adjustment operation.

(3) The method according to (1) or (2), wherein the plurality of color-grading operations comprises a global luminance adjustment operation, a global hue adjustment operation, and a global saturation adjustment operation.

(4) The method according to any one of (1) to (3), wherein the plurality of color-grading operations comprises at least one regional luminance adjustment operation, at least one regional hue adjustment operation, and at least one regional saturation adjustment operation.

(5) The method according to any one of (1) to (4), wherein obtaining the plurality of similarity measurements comprises: calculating a plurality of data structures, wherein each data structure is associated with a different one of the source image and the example frames from the plurality of example frames and wherein each data structure has a plurality of bins, each bin being associated with a unique range of chromaticity values and a unique range of luminance values and each bin including a count of the number of pixels in the image associated with that data structure that have chromacity values in the range of chromaticity values associated with that bin and that also have luminance values in the range of luminance values associated with that bin.

(6) The method according to (5), wherein each example frame from the plurality of example frames and the source image are encoded with a transfer function that covers a luminance range of X nits in Y bit depth and wherein the bins of the data structures cover the luminance range of X nits in Z bit depth, where Z is no more than half of Y.

(7) The method according to (5) or (6), wherein each example frame from the plurality of example frames and the source image are encoded with a transfer function with chromaticity values that cover a given color space in Y bit depth and wherein the bins of the data structures cover the given color space in Z bit depth, where Z is more than half of Y.

(8) The method according to any one of (5) to (7), wherein calculating the plurality of data structures further comprises down-sampling the source image prior to computing the data structure associated with the source image and down-sampling the example frames from the plurality of example frames prior to computing the data structures associated with the source image.

(9) The method according to any one of (5) to (8), wherein obtaining the plurality of similarity measurements further comprises identifying overlaps between the data structure associated with the source image and the data structures associated with the example frames.

(10) The method according to any one of (1) to (9), wherein obtaining the plurality of similarity measurements further comprises: dividing each example frame from the plurality of example frames and the source image into a plurality of horizontal bands; obtaining averages and standard deviations of luminance within each of the horizontal bands; and computing overlaps of normal distributions of the obtained averages and standard deviations of luminance within each of the horizontal bands.

(11) The method according to any one of (5) to (9), wherein obtaining the plurality of similarity measurements further comprises: identifying overlaps between the data structure associated with the source image and the data structures associated with the example frames; dividing each example frame from the plurality of example frames and the source image into a plurality of horizontal bands; obtaining averages and standard deviations of luminance within each of the horizontal bands; computing overlaps of normal distributions of the obtained averages and standard deviations of luminance within each of the horizontal bands; and calculating the similarity measurements by combining a first metric based on the identified overlaps between the data structure associated with the source image and the data structures associated with the example frames together with a second metric based on the computed overlaps of normal distributions.

(12) A color-grading system comprising: at least one controller configured to: obtain a source image for color-grading; obtain a plurality of color-grading parameter settings, wherein each color-grading parameter setting serves as an input to a color-grading operation and wherein each color-grading parameter setting is associated with a different respective example frame from a plurality of example frames; calculate a plurality of similarity measurements, each similarity measurement indicating a level of similarity between the source image and a different respective example frame from the plurality of example frames; calculate a weighted average based on the plurality of similarity measurements and the plurality of color-grading parameter settings; apply, to produce a color-graded image, the color-grading operation to the source image using the weighted average as an input parameter to the color-grading operation; and provide the color-graded image.

(13) The system according to (12) further comprising a display, wherein the controller is configured to provide the color-graded image to the display and wherein the display is configured to display the color-graded image.

(14) The system according to (13), wherein the source image comprises live content and wherein the at least one controller is configured to provide the color-graded image to the display within 200 milliseconds of obtaining the source image.

(15) The system according to any one of (12) to (14), wherein the at least one controller is configured to obtain the plurality of color-grading parameter settings prior to creation of the source image.

(16) A method, comprising: obtaining a sequence of image frames; obtaining a plurality of similarity measurements, each similarity measurement indicating a level of similarity between a different respective pair of image frames from the sequence of image frames; and selecting, from the sequence of image frames, a set of exemplar frames, by: (i) adding, to the set of exemplar frames, a first image frame from the sequence of image frames; (ii) identifying, from among the image frames not yet added to the set of exemplar frames, which image frame is the least similar, according to the similarity measurements, to the image frame(s) in the set of exemplar frames; (iii) adding, to the set of exemplar frames, the image frame identified in (ii); and (iv) repeating (ii) and (iii) until a completion condition is satisfied.

(17) The method according to (16), wherein repeating (ii) and (iii) until the completion condition is satisfied comprises repeating (ii) and (iii) until there is at least a predetermined number of exemplar frames added to the set of exemplary frames.

(18) The method according to (16) or (17), wherein repeating (ii) and (iii) until the completion condition is satisfied comprises repeating (ii) and (iii) until the image frame identified in (ii) has a similarity measurement with an image frame already added to the set of exemplary frames that is greater than a predetermined threshold.

(19) The method according to any one of (16) to (18), wherein adding, to the set of exemplar frames, the first image frame from the sequence of image frames comprises adding, to the set of exemplar frames, a most average frame from the sequence of image frames.

(20) The method according to any one of (16) to (19), wherein adding, to the set of exemplar frames, the first image frame from the sequence of image frames comprises adding, to the set of exemplar frames, a randomly selected frame from the sequence of image frames.

(21) The method according to any one of (16) to (20), wherein (ii) identifying, from among the image frames not yet added to the set of exemplar frames, which image frame is the least similar, according to the similarity measurements, to the image frame(s) in the set of exemplar frames comprises identifying, from among the image frames not yet added to the set of exemplar frames, which image frame has the smallest maximum similarity relative to any of the image frame(s) in the set of exemplar frames.

(22) The method according to any one of (16) to (21), wherein obtaining the plurality of similarity measurements comprises computing a characteristic vector for each image frame in the sequence of image frames.

(23) The method according to (22), wherein computing the characteristic vector of a given image frame comprises: down-sampling the given image to produce a down-sampled image having a lower resolution than the given image; and computing an average brightness and a standard deviation of the brightness for a plurality of horizontal zones of the down-sampled image.

(24) The method according to (22), wherein the image frames are encoded with a transfer function having a luminance range that is encoded with X bits and having at least two chromaticity parameters each encoded with Y bits and wherein computing the characteristic vector of a given image frame comprises: down-sampling the given image to produce a down-sampled image having a lower resolution than the given image; computing an average brightness and a standard deviation of the brightness for a plurality of horizontal zones of the down-sampled image; and computing a data structure from the down-sampled image, wherein the data structure includes a plurality of bins, wherein the luminance range of the transfer function is encoded with A bits in the data structure, wherein the at least two chromaticity parameters are encoded with B bits in the data structure, wherein A is less than X and B is less than Y, and wherein computing the data structure comprises counting the number of pixels from the down-sampled image associated with each bin.

(25) The method according to any one of (16) to (24) further comprising: after the completion condition is satisfied, obtaining at least one color-grading parameter setting for each exemplar frame in the set of exemplar frames, wherein each the color-grading parameter setting serves as an input to a color-grading operation.

(26) The method according to (25) further comprising: obtaining a source image for color-grading; calculating a plurality of additional similarity measurements, each additional similarity measurement indicating a level of similarity between the source image and a different respective exemplar frame from the set of exemplar frames; calculating a weighted average based on the plurality of similarity measurements and the color-grading parameter settings associated with the exemplar frames in the set of exemplar frames; applying, to produce a color-graded image, the color-grading operation to the source image using the weighted average as an input parameter to the color-grading operation; and providing the color-graded image.

(27) A computer program product having instructions that, when executed by a computing system, cause said computing system to execute the method of any of (1) to (11) or (16) to (26).

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A computer-implemented method for color-grading a source image using a plurality of color-grading operations, the method comprising:
obtaining a source image for color-grading;
obtaining, in association with each exemplar frame from a set of exemplar frames, a plurality of color-grading parameter settings, wherein each color-grading parameter setting serves as an input parameter for an associated color-grading operation out of the plurality of color-grading operations;
obtaining, for each exemplar frame from the set of exemplar frames, a similarity measurement indicating a level of similarity between the source image and the respective exemplar frame;
obtaining, for each exemplar frame from the set of exemplar frames, weighted color-grading parameter settings by applying a weight to each color-grading parameter setting of the respective exemplar frame, wherein the weight is based on the similarity measurement of the respective exemplar frame;
obtaining, for each color-grading operation of the plurality of color-grading operations, an average of the weighted color-grading parameter settings associated with the respective color-grading operation over the set of exemplar frames;
applying, to produce a color-graded image, the plurality of color-grading operations to the source image using each of the averages of the weighted color-grading parameter settings as an input parameter to its associated color-grading operation; and
providing the color-graded image.

2. The method of claim 1, wherein the plurality of color-grading operations comprises a luminance adjustment operation, a hue adjustment operation, and a saturation adjustment operation.

3. The method of claim 1, wherein the plurality of color-grading operations comprises a global luminance adjustment operation, a global hue adjustment operation, and a global saturation adjustment operation.

4. The method of any of claim 1, wherein the plurality of color-grading operations comprises at least one regional luminance adjustment operation, at least one regional hue adjustment operation, and at least one regional saturation adjustment operation.

5. The method of any of claim 1, wherein obtaining the plurality of similarity measurements comprises:
calculating a plurality of data structures, wherein each data structure is associated with a different one of the source image and the exemplar frames from the set of exemplar frames and wherein each data structure has a plurality of bins, each bin being associated with a unique range of chromaticity values and a unique range of luminance values and each bin including a count of the number of pixels in the image associated with that data structure that have chromaticity values in the range of chromaticity values associated with that bin and that also have luminance values in the range of luminance values associated with that bin.

6. The method of claim 5, wherein each exemplar frame from the set of exemplar frames and the source image are encoded with a transfer function that covers a luminance range of X nits in Y bit depth and wherein the bins of the data structures cover the luminance range of X nits in Z bit depth, where Z is no more than half of Y.

7. The method of claim 5, wherein each exemplar frame from the set of exemplar frames and the source image are encoded with a transfer function with chromaticity values that cover a given color space in Y bit depth and wherein the bins of the data structures cover the given color space in Z bit depth, where Z is more than half of Y.

8. The method of any of claim 5, wherein calculating the plurality of data structures further comprises down-sampling the source image prior to computing the data structure associated with the source image and down-sampling the exemplar frames from the set of exemplar frames prior to computing the data structures associated with the source image.

9. The method of any of claim 5, wherein obtaining the plurality of similarity measurements further comprises identifying overlaps between the data structure associated with the source image and the data structures associated with the exemplar frames.

10. The method of any of claim 1, wherein obtaining the plurality of similarity measurements further comprises:
dividing each exemplar frame from the set of exemplar frames and the source image into a plurality of horizontal bands;
obtaining averages and standard deviations of luminance within each of the horizontal bands; and
computing overlaps of normal distributions of the obtained averages and standard deviations of luminance within each of the horizontal bands.

11. The method of any of claim 5, wherein obtaining the plurality of similarity measurements further comprises:
identifying overlaps between the data structure associated with the source image and the data structures associated with the exemplar frames;
dividing each exemplar frame from the set of exemplar frames and the source image into a plurality of horizontal bands;
obtaining averages and standard deviations of luminance within each of the horizontal bands;
computing overlaps of normal distributions of the obtained averages and standard deviations of luminance within each of the horizontal bands; and
calculating the similarity measurements by combining a first metric based on the identified overlaps between the data structure associated with the source image and the data structures associated with the exemplar frames together with a second metric based on the computed overlaps of normal distributions.

12. A color-grading system comprising:
at least one controller configured to:
obtain a source image for color-grading;
obtain, in association with each exemplar frame from a set of exemplar frames, a plurality of color-grading parameter settings, wherein each color-grading parameter setting serves as an input parameter for an associated color-grading operation out of a plurality of color-grading operations;
obtain, for each exemplar frame from the set of exemplar frames, a similarity measurement indicating a level of similarity between the source image and the respective exemplar frame;
obtain, for each exemplar frame from the set of exemplar frames, weighted color-grading parameter settings by applying a weight to each color-grading parameter setting of the respective exemplar frame, wherein the weight is based on the similarity measurement of the respective exemplar frame;
obtain, for each color-grading operation of the plurality of color-grading operations, an average of the weighted color-grading parameter settings associated with the respective color-grading operation over the set of exemplar frames;
apply, to produce a color-graded image, the plurality of color-grading operations to the source image using each of the averages of the weighted color-grading parameter settings as an input parameter to its associated color-grading operation; and
provide the color-graded image.

13. The system of claim 12 further comprising a display, wherein the controller is configured to provide the color-graded image to the display and wherein the display is configured to display the color-graded image.

14. The system of claim 13, wherein the source image comprises live content and wherein the at least one controller is configured to provide the color-graded image to the display within 200 milliseconds of obtaining the source image.

15. The system of claim 12, wherein the at least one controller is configured to obtain the plurality of color-grading parameter settings prior to creation of the source image.

16. A computer-implemented method of determining a set of exemplar frames for use in at least one exemplar-based color grading operation, the method comprising:
obtaining a sequence of image frames;
obtaining a plurality of similarity measurements, each similarity measurement indicating a level of similarity between a different respective pair of image frames from the sequence of image frames; and
selecting, from the sequence of image frames, a set of exemplar frames, by:
(i) adding, to the set of exemplar frames, a first image frame from the sequence of image frames;
(ii) identifying, from among the image frames not yet added to the set of exemplar frames, which image frame is the least similar, according to the similarity measurements, to the image frame(s) in the set of exemplar frames;
(iii) adding, to the set of exemplar frames, the image frame identified in (ii); and
(iv) repeating (ii) and (iii) until a completion condition is satisfied.

17. The method of claim 16, wherein repeating (ii) and (iii) until the completion condition is satisfied comprises repeating (ii) and (iii) until there is at least a predetermined number of exemplar frames added to the set of exemplar frames.

18. The method of claim 16, wherein repeating (ii) and (iii) until the completion condition is satisfied comprises repeating (ii) and (iii) until the image frame identified in (ii) has a similarity measurement with an image frame already added to the set of exemplar frames that is greater than a predetermined threshold.

19. The method of claim 16, wherein adding, to the set of exemplar frames, the first image frame from the sequence of image frames comprises adding, to the set of exemplar frames, a most average frame from the sequence of image frames.

20. The method of claim 16, wherein adding, to the set of exemplar frames, the first image frame from the sequence of image frames comprises adding, to the set of exemplar frames, a randomly selected frame from the sequence of image frames.

21. The method of claim 16, wherein (ii) identifying, from among the image frames not yet added to the set of exemplar frames, which image frame is the least similar, according to the similarity measurements, to the image frame(s) in the set of exemplar frames comprises identifying, from among the image frames not yet added to the set of exemplar frames, which image frame has the smallest maximum similarity relative to any of the image frame(s) in the set of exemplar frames.

22. The method of claim 16, wherein obtaining the plurality of similarity measurements comprises computing a characteristic vector for each image frame in the sequence of image frames.

23. The method of claim 22, wherein computing the characteristic vector of a given image frame comprises:
down-sampling the given image to produce a down-sampled image having a lower resolution than the given image; and
computing an average brightness and a standard deviation of the brightness for a plurality of horizontal zones of the down-sampled image.

24. The method of claim 22, wherein the image frames are encoded with a transfer function having a luminance range that is encoded with X bits and having at least two chromacity parameters each encoded with Y bits and wherein computing the characteristic vector of a given image frame comprises:
down-sampling the given image to produce a down-sampled image having a lower resolution than the given image;
computing an average brightness and a standard deviation of the brightness for a plurality of horizontal zones of the down-sampled image; and
computing a data structure from the down-sampled image, wherein the data structure includes a plurality of bins, wherein the luminance range of the transfer function is encoded with A bits in the data structure, wherein the at least two chromacity parameters are encoded with B bits in the data structure, wherein A is less than X and B is less than Y, and wherein computing the data structure comprises counting the number of pixels from the down-sampled image associated with each bin.

25. The method of claim 16 further comprising:
after the completion condition is satisfied, obtaining at least one color-grading parameter setting for each exemplar frame in the set of exemplar frames, wherein each the color-grading parameter setting serves as an input to a color-grading operation.

26. The method of claim 25 further comprising:
obtaining a source image for color-grading;
calculating a plurality of additional similarity measurements, each additional similarity measurement indicating a level of similarity between the source image and a different respective exemplar frame from the set of exemplar frames;
calculating a weighted average based on the plurality of similarity measurements and the color-grading parameter settings associated with the exemplar frames in the set of exemplar frames;
applying, to produce a color-graded image, the color-grading operation to the source image using the weighted average as an input parameter to the color-grading operation; and
providing the color-graded image.

27. (canceled)
